(19) United States
(12) Patent Application Publication
(10) Pub. No.: US 2012/0002803 A1
(43) Pub. Date: Jan. 5, 2012

(54) SELF RECONFIGURING VLSI ARCHITECTURES FOR UNKNOWN SECRET PHYSICAL FUNCTIONS BASED CRYPTO SECURITY SYSTEMS

(76) Inventors: Wael Adi, Braunschweig (DE); Khaled Benkrid, Edinburgh (GB)

(21) Appl. No.: 12/829,549

(22) Filed: Jul. 2, 2010

(51) Int. Cl. H04L 9/28

(52) U.S. Cl. 380/28

(57) ABSTRACT

This invention describes the use of the features of modern reconfigurable and self-reconfigurable VLSI technology to design highly secure unknown and secret physical functions for security applications. Several examples of sample implementation scenarios for self-generated secret hard-wired cipher- and/or hash functions architectures are shown. A designed, true-random, electronic mutation process autonomously activates the creation of such secret unknown functions in a self-reconfiguring VLSI architecture. It is also shown that such mutation processes can be designed to evolve dynamically in a non-predictive manner to come up with highly secure physical security mechanisms and protocols. This self-evolving property of such functions offers a great security quality which can enhance the security and identification resilience of electronic units to levels similar to those only available in biological systems with highly accurate DNA identification and secured history tracing of living entities. The invention shows also that such unknown physical functions can be used to implement highly secure cryptographic protocols which were not possible before the availability of self-reconfiguring VLSI technology. The invention description shows also how to make use of unknown tamper-proof and secret physical mapping as hash functions and ciphers even if the exact architecture is not known to anybody. A primitive identification scenario with its core protocol using an unknown secret cipher is also described, offering high security stability and resilience.

### BACKGROUND OF THE INVENTION

FPGAs have programmable microstructures which can offer a very good infrastructure for basic cryptographic functions. The fact that each cell is independently programmable delivers great diversity for building a large number of functions. The self-reconfiguration capability offers another degree of freedom towards a changeable/evolvable architecture. An interesting recent advancement in FPGA design is the introduction of self-reconfiguration technology Error! Reference source not found. Cryptography can make use of all these capabilities to implement new core functions to complement and enhance the traditional crypto-functions. The growing complexity and flexibility of FPGA technology is promising for efficient modern security applications. In this invention, we make use of the reconfigurable FPGA architecture to generate new secret, unknown and evolving crypto mappings which form hardwired physical one-way functions corresponding to the mathematical one-way functions widely used in crypto-systems. While the basic ideas are inspired from existing FPGA structures and make use of their natural building blocks, their use could be extended to any VLSI architecture with self-reconfiguration capability and on-chip non-volatile memory.

### SUMMARY OF THE INVENTION

This invention makes use of self-configuration capabilities of modern FPGA devices to generate new mutated and evolvable security functions which are unknown even to the device owner, yet the function is perfectly usable. The first attempt addresses the construction of useable ciphering functions by linking micro-functions representing one CLB or a few adjacent CLBs (Configurable Logic Blocks) in an array architecture to construct a full ciphering function. The two particular properties of the function are: its re-configurability (hence the possibility of having scalable capability and a dynamic size which may change with time) and the possibility of keeping it completely anonymous and secret as it is changing during operation within the device without external influence. Self-reconfiguration gives the cipher novel and special evolutionary properties. These properties could establish a way towards new security functionality offering a living architecture that allows growing and/or shrinking with the progress of time. This additional functionality affecting the physical structure of a security device during its operational lifetime is a novel realizable feature in self-reconfiguring VLSI technology with many applications.

### BRIEF DESCRIPTION OF THE DRAWINGS

FIG. 1 shows a traditional simple involution function deployed in the majority of wide-spread ciphers such as DES Error! Reference source not found. or KASUMI cipher Error! Reference source not found. which was adopted for the 3^{rd} generation UMTS mobile system.

0 is a Basic Xilinx FPGA Programmable Cell and shows a traditional sample CLB (e.g. from Xilinx FPGAs) with its 4 mapping tables (LUTs). Each table has n=4 inputs resulting in a large number of possible mapping functions for each cell.

Error! Reference source not found.Error! Reference source not found. (a) is a sample Secret Function as an Unknown Secret Cipher and shows an internal autonomous TRG embedded in the system as. Error! Reference source not found.Error! Reference source not found. (b) is a Self-Reconfiguration Architecture and shows a special dedicated reconfigurable security area (DRSA).

Error! Reference source not found. is a Half slice micro-involution and shows a possible micro-involution cell implemented as a slice or alternatively in Error! Reference source not found. b is a Single CLB architecture with 4 inputs.

FIG. 5. is a Evolvable cipher function scenario that shows a possible conceptual simplified 3×3 array of such cipher. FIG. 5. b is an Example of one Xilinx slice produces two micro-involutions and shows a quick trial to generate such micro-involution in a single CLB using just the CLB's own interconnections.

Error! Reference source not found. a shows the proof of operation in an example of a macro-cipher as a one-dimensional array composed of three different random micro-involutions embodying three arbitrary distinct non linear functions f1, f2, f3 with k1, k2, k3 as micro-involution-keys. Error! Reference source not found. b illustrates embodiments in the micro-involutions.

FIG. 7 shows a basic architecture for non-predictable embodiment of evolving secret hash functions. It also exemplifies Embedding Evolutionary Structures in a FPGA Programmable Area.

FIG. 8 is a Micro Hash Function as a Micro Non-linear State Machine and shows a possible structural configuration scenario of the existing logic in each CLB representing a micro non-linear state machine with 4-inputs and one output.

FIG. 9 is a Non-Singular NLFS Architecture and shows the nonlinear feedback shift register (NFSR) architecture can be deployed as a basic structure having non-singular behavior over GF(2).

FIG. 10 is an Array Structure for a Secret Autonomous Hash-Function and demonstrates a possible rectangular interconnection configuration of such basic cells in a spare reconfigurable chip area.

FIG. 11 is a Possible Non-singular NLFS Architecture in FPGA Cell architecture as (MHSC) micro hashing or stream cipher (as running key generator). It is also a possible macro NLFSR unit mapped onto one FPGA cell as a basic unit to be self-configured and autonomously embedded in a free area of a reconfigurable VLSI architecture.

FIG. 12 is a Basic Challenge-Response Identification Marker Principle and shows a sketch of a procedure to generate identification markers as challenge-response pairs in order to identify physical devices uniquely.

FIG. 13 shows a scenario for a “secured dependency” architecture.

FIG. 14 shows a possible “Physical Identity Primitive” scenario.

FIG. 15 shows a Replacement Invasive Attach Scenario.

FIG. 16 illustrates a suggested novel protocol for device instantiation by a Trusted Authority (TA) using the secret cipher concept.

FIG. 17 is a Generic Secured Unit Identification by TA and describes a novel protocol for the secure device identification by the TA using the secret cipher concept.

### DETAILED DESCRIPTION OF THE INVENTION

### Micro-Crypto Functions in a CLB

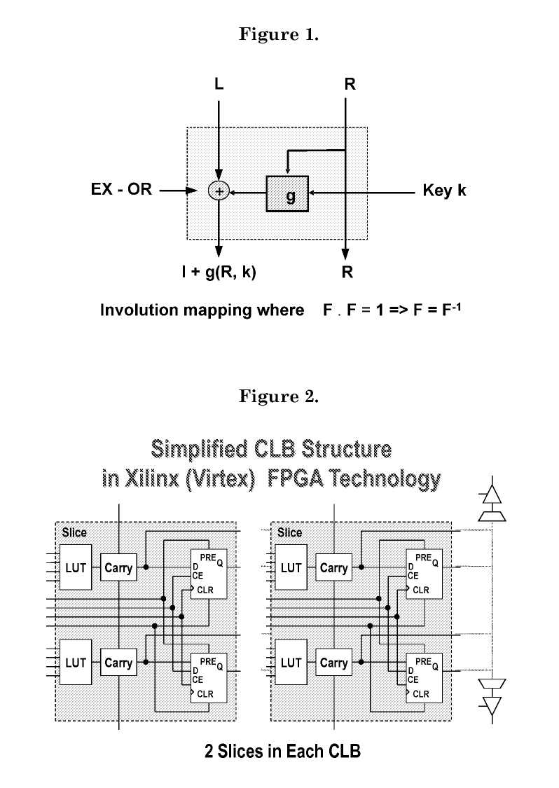

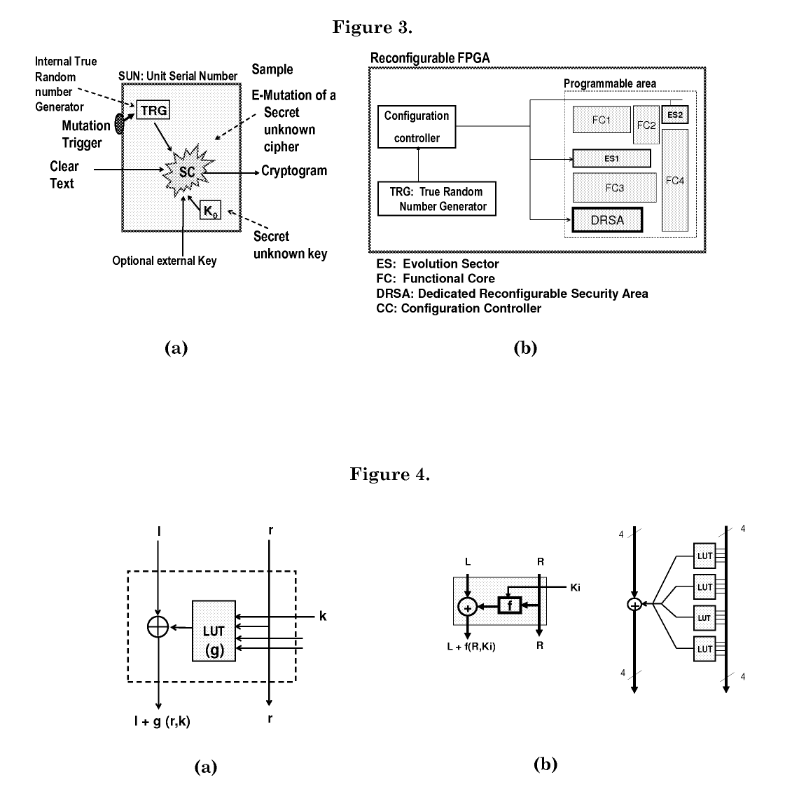

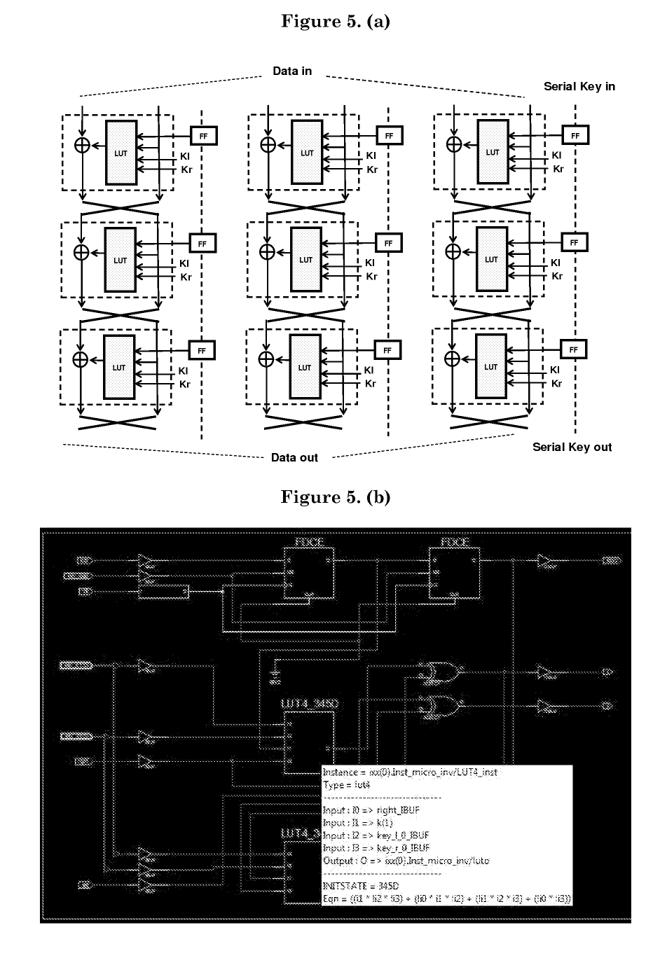

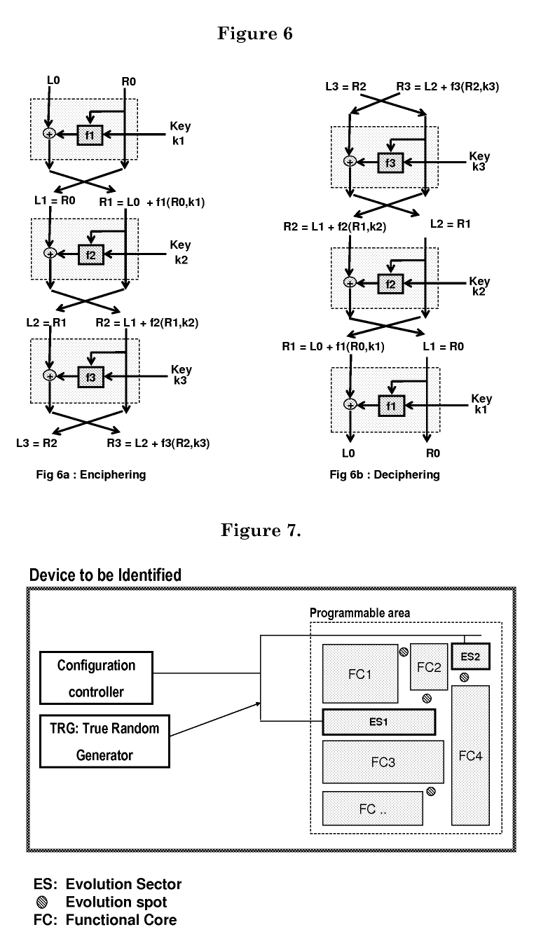

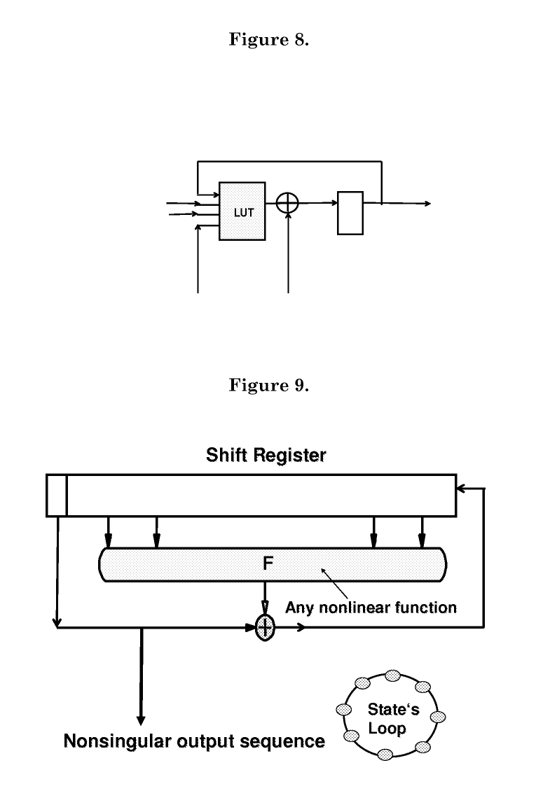

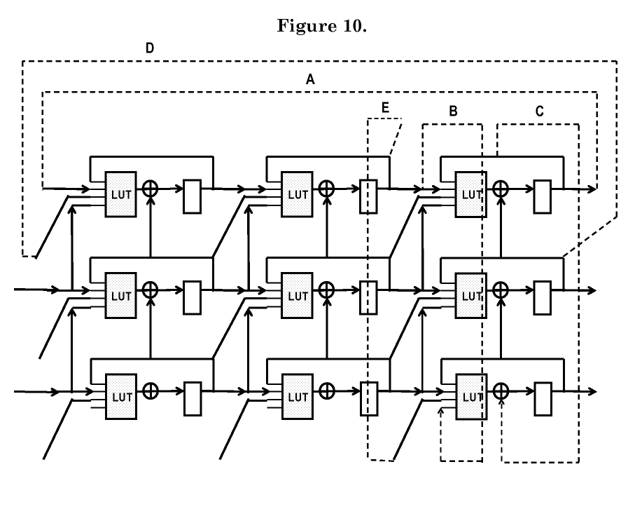

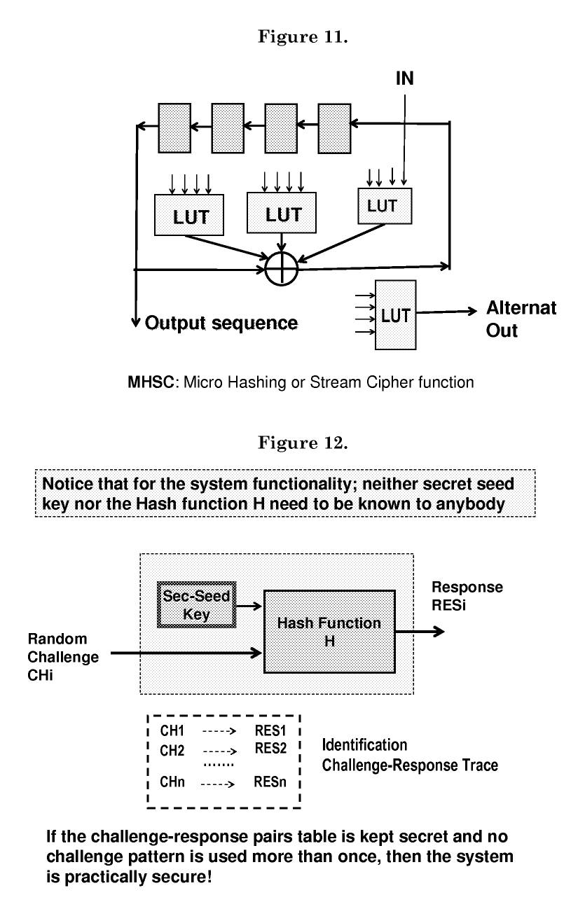

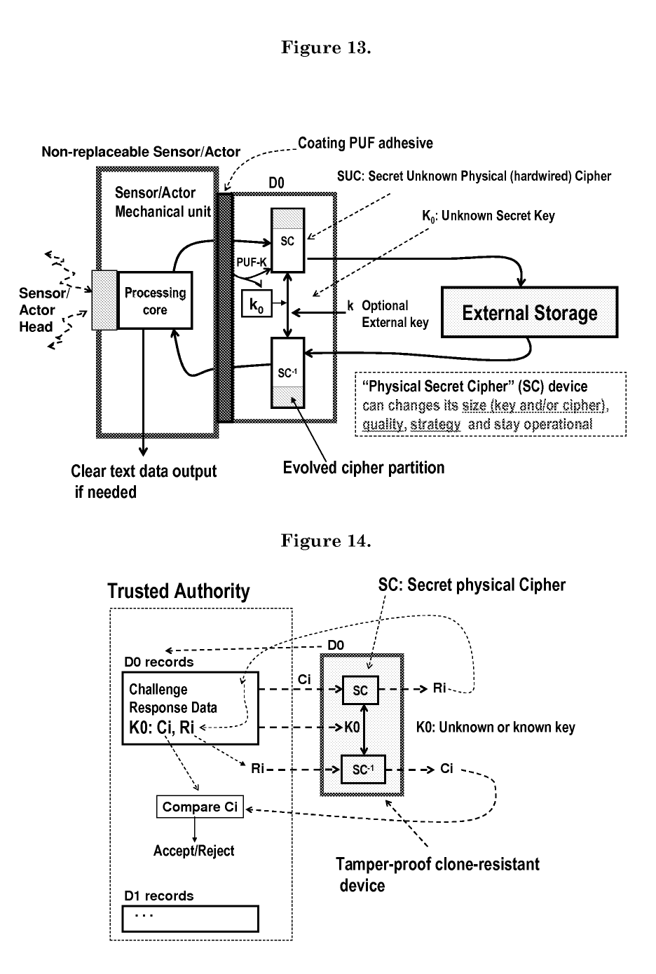

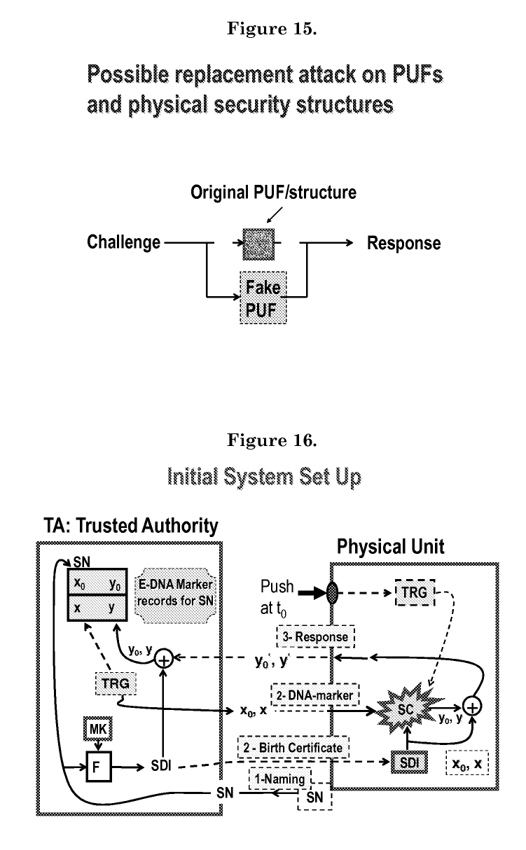

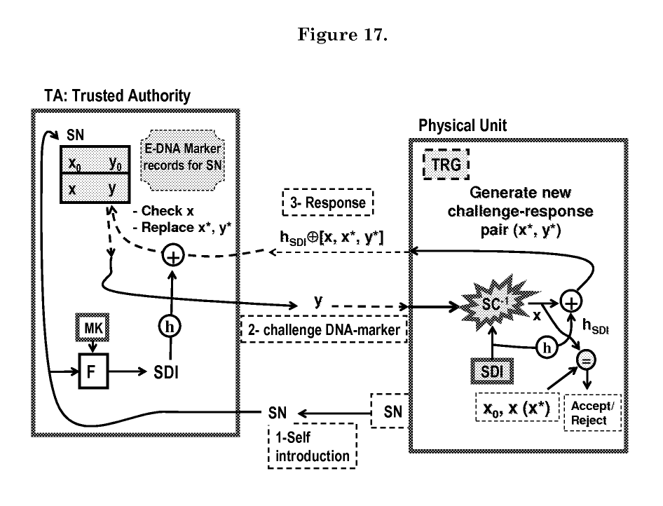

Based on existing programmable FPGA CLBs, a single CLB could be seen as a basic micro-crypto mapping. One well known and highly secure function used in cryptography is the involution function. FIG. 1 shows a traditional simple involution function deployed in the majority of wide-spread ciphers such as DES Error! Reference source not found. or KASUMI cipher Error! Reference source not found. which was adopted for the 3^{rd} generation UMTS mobile system. The fact that this function is operational for any non-linear function g with any dimension makes it a very interesting function for self-reconfiguring structures.

It is also noticed that the knowledge of the functions g is not necessary to construct an operational cipher. This particular property is a key idea to construct new ciphering functionality for special security applications which is only possible through new self-reconfigurable physical VLSI units. Unlike conventional crypto-techniques, the FPGA's physical hardware cell structure is deployed to efficiently offer the crypto mappings through its own architecture. The target of this methodology is to reach simple, extendable, and evolvable cipher-functions which are easy to integrate (even dynamically) in eventually free unused areas on an FPGA chip. The fact that the micro structure is simple leads most probably to high utilization of the available FPGA resources and hence a higher usage of the logic resources with minor overheads, if at all. The mapping capacity of a simple FPGA cell is suitable for cryptographic functions. 0 shows a traditional sample CLB (e.g. from Xilinx FPGAs) with its 4 mapping tables (LUTs) Error! Reference source not found. Each table has n=4 inputs resulting in a large number of possible mapping functions for each cell.

# of cell mappings=4·2²^{ⁿ}≈256·10³ (1)

The LUT mapping can be seen as a basic building block for hashing or ciphering micro-functions employed in a larger security function. The average utilization of the programmable area in most applications leaves at least 10% unused chip area. However, this area can be used if the interconnection structures are enhanced. Such free areas can be utilized even during chip operation if the technology allows dynamic reconfiguration. If the on-chip reconfiguration controller can take care of addition and deletion of on-chip micro-crypto structures, then new cryptographic functions can be created and deleted in each individual chip. This can take place autonomously by utilizing unused sectors designated as Evolution Sectors (ES) or in special dedicated reconfigurable security area (DRSA) as shown in Error! Reference source not found.Error! Reference source not found. (b).

One possible scenario is to let the evolution controller generate micro mappings and link them together to build accumulatively one or many evolutionary crypto-functions in one or more ES areas. Such evolving crypto-functions can be used to generate identification markers as challenge response pairs to uniquely and securely identify the electronic device as will be shown later in FIG. 12

Error! Reference source not found. a shows a possible micro-involution cell implemented as a slice or alternatively in Error! Reference source not found. b as a single CLB (refer to the involution shown in 0). In general, one CLB or few adjacent cells in other FPGA technologies can construct such micro-involution. The structure of Error! Reference source not found. is derived from the existing cell structure such that a maximum usage of the cell's logical power is achieved. The micro-involution, as one building block is certainly not secure, however cascading many such micro-involutions in a one- or two-dimensional array would produce a highly secure cipher similar to DES, or KASUMI. FIG. 5. a shows a possible conceptual simplified 3×3 array of such cipher. The flip-flop available in each slice can be used to accommodate the secret key and probably linked together as serial shift registers.

The four inputs of each LUT can be used as follows:
1. 1st bit for the input data
2. 2nd bit for the key of the micro cell
3. 3rd bit from a key kᵣ from the cell on the right.
4. 4^{th} bit from a key kₗ from the cell on the left.

Other utilization arrangements for the LUT inputs are possible if the involution is kept consistent in the sense that it is reproducible for enciphering and deciphering in the correct sequence. The deciphering process requires reversing the sequence of the key bits together with each corresponding g functions (LUT contents). A proof is sketched in FIG. 6.

The array architecture of FIG. 5a is a macro-cipher as an array of repeated micro-involutions. The challenge in such structure implementation is to reconfigure the cipher autonomously and securely in the dedicated free area by deploying permanent solid mechanisms. FIG. 5. b shows a quick trial to generate such micro-involution in a single CLB using just the CLB's own interconnections.

Error! Reference source not found. a shows the proof of operation in an example of a macro-cipher as a one-dimensional array (for a 2-dimensional array see FIG. 5a) composed of three different random micro-involutions embodying three arbitrary distinct non linear functions f1, f2, f3 with k1, k2, k3 as micro-involution-keys. The deciphering process is equivalent to the application of the enciphering scheme but with reversing the order of the used enciphering micro-functions and the corresponding keys. Furthermore the deciphering is in this case also possible without the knowledge of functions that are embodied in the micro-involutions as illustrated on Error! Reference source not found. b.

### Secret Cipher-Function and Evolution Scenario

Evolving physical hardware architecture can be the key technology for constructing evolving security properties. An internal configuration controller should take care of the autonomous reconfiguration. A true random number generator (TRG) is also required for constructing robust crypto functions. Many TRG architectures in programmable technology environments have been previously proposed as in Error! Reference source not found. and Error! Reference source not found. Notice that the LUT contents need not be equal and even need not be known to the outside world (thus called unknown cipher). If an internal autonomous TRG embedded in the system as shown in Error! Reference source not found.Error! Reference source not found. (a)-(b) is used to generate the contents of the LUTs, the system would then offer a highly secure architecture. Here, the internal TRG is triggered by a mutation event (see FIG. 3(a)) which causes the secret function e.g. cipher or hash, to create a function or change an existing function (in the case of evolution) in a way unknown to the external world, device-manufacturer and owner included. A secret unknown key K₀ may also be generated as well in the same way to be used in addition or complementary to a user-selected key K entered from outside, if required (see Error! Reference source not found. (a)).

The particular property of such evolving secret cipher, compared with the conventionally built ciphers, is that it is possible to implement a cipher that is operational even if its mappings are practically unknown to anybody (as its structure i.e. the LUT contents and its size are internal and unknown to anybody). This structural aspect is made possible by self-reconfigurable VLSI technology. Many practical applications can make use of such highly secure, unknown but still operational reversible mapping.

Another essential property of the intended architecture is its evolutionary nature. Some security applications do not require keeping the security mappings static. More security can be acquired if the structure is made dynamic such that it evolves unpredictably, driven by a true random source. This could lead to perfect security in the sense of a one-time-pad, which was proved to offer perfect secrecy. Suppose that the FPGA device can generate a structure for a secret mapping/cipher, which is provably reversible. If a device is asked to encipher a challenged secret-value at some initial time point, then only that same device can decipher it at a later time point with perfect security, as nothing is known about its cipher. Now if after each challenge a Secret-Cipher is evolved for the next challenge, the system can offer, in such scenarios, a perfect chain of physical authenticity. One possible application of a self generated secret cipher is to use that cipher to re-identify a certain physical unit if challenged to decrypt a message as a zero-knowledge proof of identity. Such security mechanisms became only possible after the device got the capability to internally modify its configuration. This functionality offers a new security technology due to the novelty of the self-configuring architecture.

### Hardware Complexity

The core of this invention is a dynamic cipher integrated in a programmable self-reconfigurable VLSI environment. A self-configuration controller manages the insertion of the micro-involutions in the unused locations inside the reconfigurable hardware (or FPGA). The configuration controller needs additional information about the location and the number of the unused CLBs in order to calculate the evolved ciphering function. CAD design tools (synthesis, mapping and routing) need to add a header to the configuration stream which contains the necessary information. A simple mapping algorithm tries to minimize global routing between the utilized CLBs. Another way is to reserve a fixed unknown area of the FPGA for these macro ciphering functions. The controller selects randomly a subset of such CLBs in each iteration process.

The content of the participating LUTs is generated using a pseudo random generator integrated with the configuration controller.

### Secret Hash Function Scenario

Physical Unclonable Functions (PUF) has been introduced making use of some inherent/intrinsic physical differences between devices to uniquely identify such electronic devices [9]-[11]. The devices identified by such technique are expected to be perfectly unclonable as the existing large mappings (PUFs) are not practically reproducible even by the same manufacturer. However, the costly sensing and/or the inherent liability of electronic devices to be sensitive to temperature and voltage drifts could make the PUF's technique inadequate for many practical applications.

The main objective of the following construction is to devise practical techniques for creating non-ambiguous constructive differences in electronic devices such that each device would define autonomously a part of its structure in a non-predictable manner. The result should become a hard-wired physical structure which can serve for physical security tasks. The structures are created in such a way that they are kept intentionally secret and non-reproducible, therefore practically hard to clone. This type of functionality becomes first possible through the self-reconfiguration property. As the reconfiguration changes are not limited to the initialization phase of such devices, a dynamic time-dependent evolution can even be considered in both space and time scale. Like all modern practically secure systems, no perfect security is expected. However, there is also no reason to exclude the possibility of attaining practically smart security mechanisms which may incrementally reach high confidence levels approaching those of biological genetic structures.

### Principle of our Unique Identification Technique

Some Spartan 3 Xilinx FPGAs were fabricated with a unique secret serial number called a device DNA stored in a tamper resistant area with no cryptographic mechanisms to re-identify the device [5]. The initial designation of that identity as DNA is at least interesting however it is far from being a secured entity.

To inspire from biological systems, the human uniqueness properties and identification methodologies can be considered. The first identity a human being gets is a given name and later an identity card, both endorsed by a trusted authority. As time progresses, new personal properties are accumulatively acquired by human beings. The born DNA identity represent an intrinsic unique identity, which is mostly used to identify individuals in real life when all other identifications do not meet the degree of trust required. On the other hand, acquired identification properties as knowledge/skills, language and other properties of a living individual would differentiate persons even if they were born as twins and even if they were successfully cloned with the same DNA. Including such self created properties to electronic devices could offer more stable and resilient security architectures. For example cloning a device would become practically equivalent to the difficulty of seeking and tracing all relevant device transactions (including possibly secret ones) with the environment. This is in most practical applications nearly impossible to achieve. Even if this could have been possible at some time and an attacker was able to clone a device and its history, the system would detect discrepancy after some time, as both cloned and non-cloned units would exhibit different evolved identity properties for the same claimed unique name or serial number. In that case, the system administration would stabilize its system security by prohibiting both units and running more generic and intensive non-conventional proofs to pick out the illegal units. This is actually the reason why the dynamically growing human community system does not collapse easily and a remedy is rather possible with more or less efforts. Therefore evolving identification architectures in the hash function would be considered.

### Self-Reconfigurable VLSI Technology

Self-reconfigurable physical hardware architecture could be deployed as a basic technology for creating (mutating) hardwired secret functions. In section 3 a micro-involution function as a basic building block of a cipher was proposed to be self-generated in an FPGA architecture. The example was based on a Xilinx programmable FPGA cell structure as that shown in FIG. 2. The involution structure was inspired from the existing programmable CLB architecture. The same strategy of section 3 would be applied for hash-architectures for identification mechanisms of physical units.

This LUT mapping can be seen as a basic building block for ciphering and hash functions. The average utilization of the programmable area in most applications leaves unused areas on the chip. If the technology allows dynamic reconfiguration using on-chip reconfiguration controller, then unpredictable addition and deletion of free programmable micro-crypto structures can be self fabricated. If this process is kept autonomous, then the resulting functions would stay secret to everybody if the devise is not invasively attacked. Programmable technologies offer also means like some hardware trap functions to prohibit reading the configured structures. Sections 9 and 10 will show possible uses of such secret (even unknown) hash and cipher functions.

### Mutating a Secret Hash Function

Evolving physical hardware architectures are the key technique to be deployed for constructing evolving accumulative properties. FIG. 7 shows a basic architecture for non-predictable embodiment of evolving secret hash functions. An internal configuration controller should take care of the autonomous reconfiguration processes. The functional core areas (FC's) are to be identified by a configuration controller and the useful free areas designated as Evolution Cores (ECs) are to be statically or dynamically monitored. The red spots represent single spare/unused cells with routable connectivity. A true random generator TRG is also required for constructing robust crypto functions. The latter causes standard hash functions to evolve in time providing fresh challenge-response markers designated as e-DNA markers inspired from the biological DNA concept [12].

Concept for a Secret Operational Hash Architecture

To demonstrate a sample realization scenario, the CLB structure of FIG. 2 is used as a basic cell structure for the device under consideration. The basic requirement from a hash function is to produce a computationally non invertible and non-predictable output for a given input. The Look-up Table (LUT) unit represents a free programmable mapping which allows for the implementation of highly non-linear mappings. Having a self-reconfiguring autonomous function, the LUT mapping could also be chosen as a true-random secret sequence loaded onto the LUT. FIG. 8 shows a possible structural configuration scenario of the existing logic in each CLB representing a micro non-linear state machine with 4-inputs and one output.

FIG. 10 demonstrates a possible rectangular interconnection configuration of such basic cells in a spare reconfigurable chip area. Such secret hash can be internally mapped into one free evolution core EC as shown in FIG. 7. Another simple basic structure with non-linear non-predictable mapping often used for stream cipher constructions [14] is also proposed. The nonlinear feedback shift register (NFSR) architecture can be deployed as a basic structure having non-singular behavior over GF(2) is shown in FIG. 9. The non-singular property produces a single loop for the register's state sequence. This property is essential to avoid generating trivial output sequences. Notice that the function F in FIG. 9 can be any nonlinear function.

FIG. 11 shows a possible macro NLFSR unit mapped onto one FPGA cell as a basic unit to be self-configured and autonomously embedded in a free area of a reconfigurable VLSI architecture. The number of input and output ports can be kept small (in best case one input and one output) to ease cascading single units (seen as evolution spots in FIG. 7) within a chip in a non-predictable secret autonomous process

Cascading many such cells possibly by interconnecting single-input single-output cells would result with a cryptographically relevant hash-function. As an example, cascading 25 cells would come up with a 100-bit cascade of non-linear secret mapping.

### Dynamic Function Evolution

Arranging and cascading such micro-machines as demonstrated in FIGS. 8, 10 and 11 in an extendible fashion results with a dynamic hash architecture, which can be deployed as a virtually-evolving structure. A simple possible initial scenario is to let each device start by having the same structure after fabrication and let the initialization of the device start by autonomously-defined random unknown selection of that structure as a reference permanent anchor configuration. Later extensions and reductions can be managed to produce evolved architectures for dynamic differentiation and more sophisticated highly secured scaleable applications.

To simplify the procedure assume that the change can proceed by increasing or decreasing the array size in an unknown and unpredictable manner (to the outside world). The unpredictable change can be accomplished in its simplest way by configuring and updating the LUT by unpredictable patterns from the true random generator TRG. The other evolution factor can be a true random change of the size of the array in both vertical and horizontal directions or by increasing or decreasing the chain of physically scattered E-spots shown in FIG. 7. Other evolution strategies can be adapted to fit to the individual properties of the deployed FPGA cell-technology and the intended security protocols.

### Security Application Scenarios

Two application scenarios for the resulting secret hash-function and secret cipher are demonstrated below.

### Authentication Using a Secret Hash Function

The “secret hash functions” are new entities essentially different from the conventional known hash function designs. They can be however used in the same fashion to generate identification markers as challenge-response pairs in order to identify physical devices uniquely. The procedure is sketched in FIG. 12. Notice that neither the knowledge of the secret seed key nor the knowledge of the hash function is necessary to operate the challenge-response identification mechanism. This fact leads to the idea of accumulatively changing/evolving the hash function as a part of the device personality and keep tracing its evolution generations.

The same identification technique is used for PUF-based identification [10-11] with the difference that the secret seed key and the physical mapping are unchangeable as they are physically inherent intrinsic mappings. Identification using PUFs is actually the ultimate solution if the inherent properties are consistently reproducible (i.e. device and PUF response are temperature voltage and environment independent).

The proposed approach is generating a consistent unknown function similar to that of the PUF however in a secret, self constructing and cryptologically secure manner.

### Secret Cipher for Clone-Resistant Units

The secret unknown physical cipher is a new aspect for cryptographic application environments. A cipher was always assumed to be impossible to keep secret; therefore all security protocols are dealing with the open cipher concept as a basic assumption. The ability to generate a secret and even unknown operational cipher delivers new application horizons. Two sample applications primitives are shown:

### A Primitive for “Secured Dependency” Scenario

FIG. 13 shows a scenario for a “secured dependency” architecture. The application primitive is linking a process to be protected to a physical unit D0. The unit D0 includes a secret cipher SC. In the initialization phase of the system, all operational data for a certain process are stored encrypted by the secret cipher in some external storage. After a certain short operating time, the process would not be possible to operate without having the physical unit D0. All process related data are stored initially after encryption by a secret cipher of D0 which no one knows. Even the ciphering key could be selected as unknown K₀ or provided from outside D0 to add additional user controlled dependency to the system. If the unit D0 is linked to a mechanical part by some adhesive as a coating PUF and linked to the SC secret key K₀ and/or its parameters, then a secured clone-resistant mechatronic unit as sensor/actor is achieved. If the mechanical unit is separated from D0, then the PUF would be destroyed and the SC is irreversibly damaged and can not be cloned. In difference to the mechatronic unit, the external storage can be physically replaced and copied however it has no use without the mechatronic unit. The data on the external storage have only their use with the existing physical link to D0. Many vehicular and data mining security applications require such physical security infrastructure.

A variety of other similar dependency scenarios can be constructed out of this primitive dependency scenario in a similar way.

### A Security Primitive for “Physical Identity”

FIG. 14 shows a possible “Physical Identity Primitive” scenario. A trusted Authority (TA) can challenge a device D0 having a secret physical cipher (SC) at some initial time point. A challenge-response pair set Ci, Ri can be generated in a single set-up process after delivering a certain user dependent key K0. At a later time point, only D0 would be able to deliver the correct decryption to the response Ri for a certain selected Ci. In order to keep the Ri-Ci pairs used for just one time, an update and dynamic identity management protocol (see example section 10) should refresh the challenge-response process and avoid any challenge repetition in an open network.

### Protocols for the Secure Device Instantiation and Identification Using Unknown Secret Ciphers

### Device Instantiation

FIG. 16 illustrates a suggested novel protocol for device instantiation by a Trusted Authority (TA) using the secret cipher concept. The protocol consists of the following three passes:

### Pass 1

The TA pushes a button to generate a secret cipher (SC) on the device which is defined by a true random number generated by a true random number generator (TRG). The TA also gets the device's Serial Number (SN) from the manufacturer.

### Pass 2

Given the device's SN, the TA generates a unique secure device identity (SDI) based on the device's SN using a Master Key (MK) i.e. SDI=F_{MK}(SN) where F is some TA's cipher e.g. AES or KASUMI. The TA sends SDI to the device as part of its birth certificate. The SDI is stored on-chip in a write-only-memory as a key for the secret cipher (SC).
NB. The SC security architecture is thus generated by two contributions: a first by the device itself through a true random number generator that generates the cipher (see pass 1) and second by the TA-generated secure device identity (SDI) as signature.
In addition to the SDI, the TA also generates two random numbers, or DNA markers, x₀ and x, and challenges the device with them.

### Pass 3

In response to the challenge, the device generates SC_{SDI}(x₀,x)=(y₀,y) and stores x₀ and x on-chip in a write-only-memory. The device confuses y₀ and y by EXORing with SDI to generate (y₀′,y′)=SDI⊕(y₀,y) and send them on to the TA. The TA reconstructs y₀,y from y₀′,y′ by EXORing with SDI. (x₀,x) and (y₀,y) are then stored by the TA as a record or birth certificate for device SN.

### Primitive Identification Scenario

FIG. 17 describes a novel protocol for the secure device identification by the TA using the secret cipher concept. The protocol consists of the following three passes:

### Pass 1

The device self-introduces itself to the TA by sending its serial number (SN).

### Pass 2

The TA generates SDI from SN and challenges the device with a previous challenge response (or DNA marker) y stored in the device's birth certificate.

### Pass 3

The device decrypts y to get the corresponding challenge x, and then only accepts the TA identification request if the decrypted challenge x is stored in its write-only memory. Otherwise, the device stalls the communication. If x is found in the write-only memory, the device generates a new challenge-response pair (x*,y*) through the true random number generator and sends (x,x*,y*) to the TA, confused by EXORing with h_{SDI}, where h is a hash function. At the same time, x is replaced by x* in the device's write-only-memory.

Finally, the TA reconstructs (x,x*,y*) by EXORing with h_{SDI}. It then checks the resulting x against the x stored in the device's birth certificate. If these are equal, the device is deemed authentic, and the previous challenge response pair (x,y) in the birth certificate is subsequently replaced by the new pair (x*,y*).

We claim:

1. A novel “secret unknown security function” (e.g. ciphers, hash functions) that provides ultimate security levels in electronic systems comprising: an internal, dynamic and physical true random generation of a secret unknown non-volatile hardwired function that is unknown even to the device owners, yet the function is perfectly usable, and a unique physical identity that is not sensitive to environmental effects such as temperature, radiation or swings in supply energy as it is the case in current Physical Unclonable Functions (PUFs) technology, and an internal true random number generator (TRG) that when triggered once or optionally several times by a “mutation event” which causes the function e.g. cipher or hash function, in addition to some optional internal unknown secret key K₀, to be created or changed in a way unknown to the external world.

2. A VLSI device suitable for creating embedded secret unknown security functions comprising as shown in the sample block diagram of FIG. 3 (a) and (b) where said device comprises: a self reconfiguring capability in part or in the whole of its configurable area, the said area includes functional core areas covering device tasks as functional cores (FC) and other free areas called evolution sectors (ES) which are free for further use, and a true random digital stream generator unit (TRG), and a configuration controller (CC) unit integrated in the same VLSI area which is responsible for managing the internal self-reconfiguration process during the device lifetime e.g. the said TRG is allowed through the CC to deliver unknown random digital streams after device production and triggered/started by device owner at any time to the ES units to fill the look-up tables and influence the generation of unknown arrays of micro-functions and their random placement in the currently free ES areas, such that all such functions creation cannot be influenced by device manufacturer and device owner, and they stay fully random and unknown to anybody.

3. The device according to claim 2 that can generate a secret unknown cipher SC as one or more pre-defined micro involution (MI) functions (or self-inverting functions) and mapped onto programmable cell-units in a single bit architecture form or as in a 4-bit parallel architecture form, and having the mapping function as a single or multiple look-up tables (LUTs) of a configurable cell, the contents of the LUTs are loaded with unknown random digital streams from the TRG source, and where the involution functions are adapted to the existing pre-defined cell structure to make full use of its logic resources depending on the selected technology.

4. The device according to claim 3 where the MI functions in number and distribution over the programmable ES area are completely influenced by the TRG such that two devices coming from the same batch and operating at the same time would “practically” never result in the same involution functions.

5. The device according to claim 4 where the resulting MI functions are cascaded and configured by the CC unit as arrays influenced in size and structure by the TRG such that the micro involutions get input bit contributions from both left and right MI units' outputs in addition to those coming from the cipher key register.

6. The device of claim 5 where the array of MIs is configured such that the sequence of involutions can be reversed to selectively achieve encryption or decryption operations.

7. The device of claim 1 where the functions may change in time or evolve in a predictable or unpredictable manner to become different from the previous ones in an unknown manner, in content, size and structure, however, they keep being operational despite their evolving secret functions, additionally, the evolutionary secret cipher can be used to cope with different security levels as functions grow or shrink in size and complexity accordingly.

8. The device of claim 2 where the functions may change in time or evolve in a predictable or unpredictable manner to become different from the previous ones in an unknown manner, in content, size and structure, however, they keep being operational despite their evolving secret functions, additionally, the evolutionary secret cipher can be used to cope with different security levels as functions grow or shrink in size and complexity accordingly.

9. The device of claim 3 where the functions may change in time or evolve in a predictable or unpredictable manner to become different from the previous ones in an unknown manner, in content, size and structure, however, they keep being operational despite their evolving secret functions, additionally, the evolutionary secret cipher can be used to cope with different security levels as functions grow or shrink in size and complexity accordingly.

10. The device of claim 4 where the functions may change in time or evolve in a predictable or unpredictable manner to become different from the previous ones in an unknown manner, in content, size and structure, however, they keep being operational despite their evolving secret functions, additionally, the evolutionary secret cipher can be used to cope with different security levels as functions grow or shrink in size and complexity accordingly.

11. The device of claim 5 where the functions may change in time or evolve in a predictable or unpredictable manner to become different from the previous ones in an unknown manner, in content, size and structure, however, they keep being operational despite their evolving secret functions, additionally, the evolutionary secret cipher can be used to cope with different security levels as functions grow or shrink in size and complexity accordingly.

12. The device of claim 6 where the functions may change in time or evolve in a predictable or unpredictable manner to become different from the previous ones in an unknown manner, in content, size and structure, however, they keep being operational despite their evolving secret functions, additionally, the evolutionary secret cipher can be used to cope with different security levels as functions grow or shrink in size and complexity accordingly.

13. The device according to claim 2 which can further accommodate one or more pre-defined micro hash (MH) functions, where in it, a micro non-linear state machine is used as a MH function such that an array connecting these can be self created in a sample of two or more dimensional array, wherein regular feedback links as D and A in the horizontal direction and as B and C in the vertical direction close the function loop, where the LUTs are randomly filled up with unknown random patterns delivered from the TRG unit.

14. The device according to claim 2 which can further accommodate one or more pre-defined micro hash or running key generator for a stream cipher (MHSC) functions, where in it, a micro non-singular non-linear feedback shift register is used and where the LUTs are randomly filled up with unknown random patterns from the TRG unit.

15. The device according to claims 1 that can accommodate a secret unknown cipher block SC and its deciphering inverse SC⁻¹, SC can optionally be evolvable according to claim 7, and physically linked to a mechanical unit, and the physical link may used as adhesive such as coating PUF to generate a secret unknown repeatable constant digital value linked as a key PUF-K for SC and SC⁻¹ such that it is irreversibly destroyed when the mechanical unit is separated from the SC unit, and a secured dependency is thus created between the mechanical and the electronic SC unit resulting in a unique non-replaceable mechatronic unit as the data produced at the first instance of usage can never be subsequently reconstructed from the external storage if the mechatronic device is illegally replaced or destroyed as the data has been encrypted with a secret cipher not known to anybody, where the external storage is replaceable if the stored data is copied in its encrypted format, and only the mechatronic device can decrypt this data subsequently and deliver it if required to the outside world via “Clear text data output”, and a secret unknown non-volatile cipher-key register K₀ is embedded in the non-volatile reconfigurable architecture, an optional external user-defined key K could be used instead of K₀ or jointly with K₀.

16. The device according to claims 3 that can accommodate a secret unknown cipher block SC and its deciphering inverse SC⁻¹, SC can optionally be evolvable according to claim 7, and physically linked to a mechanical unit, and the physical link may used as adhesive such as coating PUF to generate a secret unknown repeatable constant digital value linked as a key PUF-K for SC and SC⁻¹ such that it is irreversibly destroyed when the mechanical unit is separated from the SC unit, and a secured dependency is thus created between the mechanical and the electronic SC unit resulting in a unique non-replaceable mechatronic unit as the data produced at the first instance of usage can never be subsequently reconstructed from the external storage if the mechatronic device is illegally replaced or destroyed as the data has been encrypted with a secret cipher not known to anybody, where the external storage is replaceable if the stored data is copied in its encrypted format, and only the mechatronic device can decrypt this data subsequently and deliver it if required to the outside world via “Clear text data output”, and a secret unknown non-volatile cipher-key register K₀ is embedded in the non-volatile reconfigurable architecture, an optional external user-defined key K could be used instead of K₀ or jointly with K₀.

17. The device having SC according to claims 9 that can accommodate in a special embodiment as in the example of FIG. 14 a secret unknown cipher block SC and its deciphering inverse SC⁻¹ (SC can be optionally evolvable according to claim 7), physically integrated in an electronic device which becomes re-identifiable and clone-resistant, where the device can be re-identified by checking its capability to encipher or decipher a previously secretly challenged ciphering or deciphering operation (Ci, Ri) as shown in the example of FIG. 14. In it, the device is challenged to decipher a previously recorded Ri by some trusted authority to deliver the correct Ci. As nobody knows the cipher SC, only the same physical device can deliver the right answer Ci.

18. The device according to claims 1, 3 and 9 can accommodate a secret unknown cipher block SC and its deciphering inverse SC⁻¹, SC can optionally be evolvable according to claim 7, and physically linked to a mechanical unit, and the physical link may used as adhesive such as coating PUF to generate a secret unknown repeatable constant digital value linked as a key PUF-K for SC and SC⁻¹ such that it is irreversibly destroyed when the mechanical unit is separated from the SC unit, and a secured dependency is thus created between the mechanical and the electronic SC unit resulting in a unique non-replaceable mechatronic unit as the data produced at the first instance of usage can never be subsequently reconstructed from the external storage if the mechatronic device is illegally replaced or destroyed as the data has been encrypted with a secret cipher not known to anybody, where the external storage is replaceable if the stored data is copied in its encrypted format, and only the mechatronic device can decrypt this data subsequently and deliver it if required to the outside world via “Clear text data output”, and a secret unknown non-volatile cipher-key register K₀ is embedded in the non-volatile reconfigurable architecture, an optional external user-defined key K could be used instead of K₀ or jointly with K₀.

19. The device according to claim 11 that can be realized in a special fine tuned embodiment as described in the 3 Pass generic initialization protocol where the device instantiation is performed by a Trusted Authority (TA) using a three-pass protocol as follows:
Pass 1
The TA pushes a button to generate a secret cipher (SC) on the device which is defined by a true random number generated by a true random number generator (TRG) according to claim 2. The TA also gets the device's Serial Number (SN) from the manufacturer.
Pass 2
Given the device's SN, the TA generates a unique secure device identity (SDI) based on the device's SN using a Master Key (MK) i.e. SDI=F_{MK}(SN) where F is a TA's cipher e.g. AES or KASUMI. The TA sends SDI to the device as part of its birth certificate. The SDI is stored on-chip in a write-only-memory as a key for the secret cipher (SC).
NB. The security architecture is thus generated by two contributions: a first by the unknown secret cipher SC through a true random number generator that generates the cipher (see pass 1) and second by the TA-generated secure device identity (SDI).
In addition to the SDI, the TA also generates two random numbers, or DNA markers, x₀ and x, and challenges the device with them.
Pass 3
In response to the challenge, the device generates SC_{SDI}(x₀,x)=(y₀,y) and stores x₀ and x on-device in a non-volatile-memory.
The device confuses y₀ and y by EXORing with SDI or preferably a one-way mapping of it to generate (y₀′,y′)=SDI ⊕ (y₀,y) and send them on to the TA. The TA reconstructs y₀,y from y₀′,y′ by EXORing with SDI. (x₀,x) and (y₀,y) are then stored by the TA as a record or birth certificate marker for device SN. x₀ and y₀ are kept as reserve reference challenge to synchronize the system in case of failure.
According to the sample generic identification protocol of FIG. 17, the trusted authority TA can re-identify the same device by a three-pass protocol:
Pass 1
The device self-introduces itself to the TA by sending its serial number (SN).
Pass 2
The TA generates SDI from SN and challenges the device with a previous challenge response (or as DNA marker) y stored in the device's birth certificate records by TA.
Pass 3
The device decrypts y to get the corresponding challenge x, and then only accepts the TA identification request if the decrypted challenge x is stored in its write-only memory. Otherwise, the device stalls the communication. If x is found in the write-only memory, the device generates a new challenge-response pair (x*,y*) through the true random number generator and sends (x,x*,y*) to the TA, confused by EXORing with h_{SDI}, where h is a hash function. At the same time, x is replaced by x* in the device's write-only-memory.
Finally, the TA reconstructs (x,x*,y*) by EXORing with h_{SDI}. It then checks the resulting x against the x stored in the device's birth certificate. If these are equal, the device is deemed authentic, and the previous challenge response pair (x,y) in the birth certificate is subsequently replaced by the new pair (x*,y*) to avoid repeating the same challenge twice in a future identification over unsecured networks.
